(19) United States
(12) Patent Application Publication
(10) Pub. No.: US 2014/0279813 A1
(43) Pub. Date: Sep. 18, 2014

(54) RANDOM NUMBER GENERATOR AND RANDOM NUMBER HEALTH TEST METHOD THEREOF

(71) Applicant: Samsung Electronics Co., Ltd., Suwon-Si (KR)

(72) Inventor: Ihor VASYLTSOV, Suwon-si (KR)

(73) Assignee: SAMSUNG ELECTRONICS CO., LTD., Suwon-Si (KR)

(21) Appl. No.: 14/088,622

(22) Filed: Nov. 25, 2013

(30) Foreign Application Priority Data
Mar. 12, 2013 (KR) 10-2013-0026257

(51) Int. Cl. G06N 5/04

(52) U.S. Cl. CPC G06N 5/04
USPC 706/52

(57) ABSTRACT

A random number health test method according to the inventive concepts including generating a random number, counting occurrences of at least two words in the generated random number, respectively, calculating probability values corresponding to occurrences of the two counted words; calculating minimum entropies (Hmin) of the respective probability values, and determining health of the generated random numbers using the calculated minimum entropies (Hmin) may be provided.

### CROSS-REFERENCE TO RELATED APPLICATIONS

This U.S. non-provisional patent application claims priority under 35 U.S.C. §119 of Korean Patent Application No. 10-2013-0026257, filed on Mar. 12, 2013, the entire contents of which are hereby incorporated by reference.

### BACKGROUND OF THE INVENTION

The present inventive concepts herein relate to random number generators and/or random number health test methods thereof.

One example of a random number is a pseudo random number made by mathematical formulas, software, and a true random number (TRN) generated by a physical noise source. The pseudo random number can be generated according to specific mathematical formulas. Because the pseudo random number is predictable depending on a situation, and has periodicity and regularity depending on its generation method, the pseudo random number is not completely random. Thus, the pseudo random number may not be appropriate for applications in a system requiring tight security because health of random numbers being output from a random number generator is directly related to the security of the whole system. Accordingly, the true random number (TRN) may be appropriate for the system requiring tight security. When generating the true random number (TRN), the random number generator, which generates a random number using an external noise source, can be affected by different external factors. Thus, the external factors can affect the health of the random number. Statistically, weak data may be generated due to the effect of the external factors.

Health of random numbers is directly related to the security of the system. If a random number does not satisfy a certain statistical property, has specific periodicity, and/or specific regularity, values of random numbers may be predictable. Because the predictable random numbers are used as a security key of the system, the security of the system may be threatened. Thus, statistically weak data which does not satisfy a certain statistical property may not be appropriate as a random number to be used in the system requiring tight security. Accordingly, the random number being generated has to satisfy a certain statistical property requirement, for example, the National Institute of Standard and Technology Special Publication 800-90 (NIST SP 800-90).

### SUMMARY

According to an example embodiment, a random number health test method includes generating a random number, counting occurrences of at least two words in the generated random number, respectively, calculating probability values corresponding to occurrences of the two counted words, calculating minimum entropies (Hmin) of the respective probability values, and determining health of the generated random numbers using the calculated minimum entropies (Hmin).

Sizes of the two words may be different from each other.

The two words may include a first word and a second word, the first word consisting of one or more ‘1’ words, the second word consisting of one or more ‘0’ words, and the first and second words being a same size

The calculating probability values may calculate a first probability value of the first word and a second probability value of the second word.

The calculating probability values may calculate a probability value of a greater count value between a count value of the first word and a count value of the second word.

The calculating minimum entropies (Hmin) may further include calculating a minimum entropy (Hmin) on the probability value of the greater count value.

The calculating minimum entropies (Hmin) may calculate each of the minimum entropies (Hmin) based on Hₘᵢₙ=−log₂(Pₘₐₓ), wherein Pmax is a probability value of each of the two words.

The calculating minimum entropies (Hmin) may calculate the minimum entropies (Hmin) using a piece linear approximation method. The piece linear approximation method may use a table storing a plurality of approximation coefficients corresponding to respective probabilities of a plurality of ranges of the respective counted words.

The determining health of the generated random number may determine the health of the random number using a health determination function value, and the health determination function value may be a difference between the calculated minimum entropies.

The method may further includes outputting a smallest minimum entropy (Hmin) among the calculated minimum entropies (Hmin), after determining the health of the random number, as a health result value of the random number.

According to an example embodiment, a random number health test method includes generating a random number, calculating a first minimum entropy (Hmin) of a first word, the first word consisting of one or more ‘1’ words in the generated random number, calculating a second minimum entropy (Hmin) of a second word, the second word consisting of one or more ‘0’ words in the generated random number, calculating a health determination function value based on the first and second minimum entropies (Hmin), determining whether to output one of the first and second minimum entropies based on a health determination function value and a reference value.

The method further includes calculating a third minimum entropy (Hmin) of third word, the third word consisting of one or more ‘0’ words and having a same size as the first word. The determining determines to output a smaller one between the first and third minimum entropies (Hmin) as an updated random number if the health determination function value is smaller than the reference value.

The method may further includes counting the first word to calculate a probability value of the counted first word, counting the second word to calculate a probability value of the counted second word, and counting a third word to calculate a probability value of a third word, the third word consisting of one or more ‘0’ words and having a same size as the first word.

The method may further includes counting the first word to calculate a probability value of the counted first word, counting the second word to calculate a probability value of the counted second word, and changing ‘1’ into ‘0’ in the random number to calculate a probability value of a third word, the third word consisting of one or more ‘0’ words and having a same size as the first word.

The first word may be ‘1’ and the second word may be ‘11’.

According to an example embodiment, a piece linear approximation method for calculating a minimum entropy (Hmin) includes selecting a range of approximation coefficients corresponding to a probability of a word, applying piece linear approximation coefficients corresponding to the selected range to a computation block, and computing the minimum entropy (Hmin) using the applied piece linear approximation coefficients.

The method may further include decomposing and storing the piece linear approximation coefficients in a memory table.

The method may further include loading piece linear approximation coefficients into the memory table in a factorized form.

The method may further include calculating temporary coefficients in parallel with the applying or between the applying and the computing.

The computing may include summing the calculated temporary coefficients to calculate the minimum entropy (Hmin) value.

### BRIEF DESCRIPTION OF THE DRAWINGS

Example embodiments of the inventive concepts will be described below in more detail with reference to the accompanying drawings. The example embodiments of the inventive concepts may, however, be embodied in different forms and should not be constructed as limited to the embodiments set forth herein. Rather, these embodiments are provided so that this disclosure will be thorough and complete, and will fully convey the scope of the inventive concepts to those skilled in the art. Like numbers refer to like elements throughout.

FIG. 1 is a block diagram illustrating a random number generator in accordance with an example embodiment of the inventive concepts.

FIG. 2 is a flow chart illustrating a random number health test method of the health test unit illustrated in FIG. 1.

FIG. 3 is a flow chart illustrating a random number health test method in accordance with an example embodiment of the inventive concepts.

FIG. 4 is a block diagram illustrating an example embodiment realizing a random number health test method in accordance with the inventive concepts.

FIG. 5 is a block diagram illustrating another example embodiment realizing a random number health test method in accordance with the inventive concepts.

FIG. 6 is a block diagram illustrating still another example embodiment realizing a random number health test method in accordance with the inventive concepts.

FIG. 7 is a drawing illustrating a 2-piece linear approximation of a minimum entropy (Hmin) function dependent on a value of Pr(1).

FIG. 8 is a drawing illustrating an error rate percent with consideration for the minimum entropy (Hmin) value ideally calculated.

FIG. 9 is a flow chart illustrating a piece linear approximation method for the minimum entropy (Hmin) function in accordance with an example embodiment of the inventive concepts.

FIG. 10 is a drawing illustrating a piece linear approximation method for the minimum entropy (Hmin) function in accordance with an example embodiment of the inventive concepts.

FIG. 11 is a drawing illustrating a first example embodiment of a 2-piece linear approximation method for the minimum entropy (Hmin) function in accordance with the inventive concepts.

FIG. 12 is a drawing illustrating a second example embodiment of a 2-piece linear approximation method for the minimum entropy (Hmin) function in accordance with the inventive concepts.

FIG. 13 is a drawing illustrating a third example embodiment of a 2-piece linear approximation method for the minimum entropy (Hmin) function in accordance with the inventive concepts.

FIG. 14 is a block diagram illustrating a security system including a crypto process having a random number generator in accordance with the inventive concepts.

FIG. 15 is a block diagram illustrating an eMMC (embedded multimedia card) in accordance with some example embodiments of the inventive concepts.

### DETAILED DESCRIPTION

Example embodiments of the inventive concepts will be described more fully hereinafter with reference to the accompanying drawings, in which some example embodiments of the invention are shown. The inventive concepts may, however, be embodied in many different forms and should not be construed as being limited to the embodiments set forth herein. Rather, these example embodiments are provided so that this disclosure will be thorough and complete, and will fully convey the scope of the inventive concepts to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof. Expressions such as “at least one of,” when preceding a list of elements, modify the entire list of elements and do not modify the individual elements of the list.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

FIG. 1 is a block diagram illustrating a random number generator in accordance with an example embodiment of the inventive concepts. A random number generator 100 includes a random number generation unit 120, a health test unit 140 and an output unit 160.

The random number generation unit 120 generates a true random number (TRN) from a physical noise source. The physical noise source may be embodied by a meta-oscillator.

The health test unit 140 estimates health of the true random number (TRN) using a minimum entropy (Hmin), and outputs an error signal ERR or a minimum entropy (Hmin) indicating health of the true random number (TRN) depending on the estimated health result. The health of the random number can be estimated by various methods and/or standards using the minimum entropy (Hmin). The random number generation unit 120 may be configured to satisfy random number health requirements according to the National Institute of Standard and Technology Special Publication 800-90 (NIST SP 800-90) standard. The NIST SP 800-90 standard determines health of a random number using minimum entropy estimation (MEE). The minimum entropy (Hmin) satisfies a mathematical formula 1 below.

Hₘᵢₙ=−log₂(Pₘₐₓ), [Mathematical formula 1]

where Pmax is the maximum value among all probability values (Pi) of a specific word size (w) being output from the random number generation unit 120. In case of implementing an on-line test, the minimum entropy (Hmin) matrix may be used. When the word size (w) is 1, a serious weakness may be sensed with relative ease. However, when the word size (w) is more than 4, sensing a serious weakness may take up too many resources.

To implement an effective on-line test using the minimum entropy (Hmin) estimation, the following characteristics may be used. First, a distribution of probability values depends on the word size (w) and a probability value Pr(1) of ‘1’ in a random sample. Second, for a distribution of independent bits, probability of word ‘000 . . . ’ tends to a limit Pr(‘000 . . . ’)→min/max and probability of word ‘111 . . . ’ tends to an opposite limit Pr(‘111 . . . ’)→max/min. Third, minimum entropy (Hmin) values of different word sizes (w1, w2, . . . ) are always in a linear relationship in a same random sample (Hmin_w1˜Hmin_w2).

The output unit 160 may or may not output a random number (RN) depending on an estimation result of the health test unit 140. If a random number (RN) satisfies a statistical range, the random number (RN) is output. If not, the random number (RN) is not output.

Accordingly, the random number generator 100 is configured to test health of random numbers using the minimum entropy (Hmin) and output random numbers depending on the test result.

FIG. 2 is a flow chart illustrating a random number health test method of the health test unit 140 illustrated in FIG. 1. Referring to FIGS. 1 and 2, a random number health test method is as follows. The random number generation unit 120 generates a true random number (TRN) sample. The health test unit 140 counts the respective number of occurrences of at least two words in the generated true random number (TRN) sample (S110). Sizes of the two words may be different from each other. Probability values corresponding to the numbers of occurrences of the two counted words are calculated (S 120). Minimum entropies (Hmin) of the probability values of the two words are calculated, respectively (S130). Health of the random numbers is determined using the calculated minimum entropy (Hmin) (S140). For instance, health of the random numbers may be determined using a plurality of minimum entropies (Hmin) and a health determination function related to the sizes of the words.

A conventional random number generator generally calculates the minimum entropy (Hmin) by counting all the words of a desired (or alternatively, predetermined) word size with respect to generated random numbers and determines health of the random numbers according to the calculation result. Because the conventional random number generator performs a counting operation on all words to determine health of random numbers, it may take up, for example, a relatively large physical space and/or a relatively long time for determining health of random numbers.

By calculating health of random numbers using the minimum entropy (Hmin) corresponding to at least two words of different word sizes, the random number generator 100 according to the inventive concepts can greatly reduce system resources (e.g., a physical space to accommodate the random number generator 100 and time for determining health of random numbers) as compared with the conventional random number generator.

The random number health test method of the inventive concepts may be performed based on a statistical property of random sequence and an algebraic property.

FIG. 3 is a flow chart illustrating a random number health test method in accordance with an example embodiment of the inventive concepts. Referring to FIG. 3, an n-bit input stream is output from the random number generation unit 120. The number of ‘00 . . . . ’ and ‘11 . . . . ’ words occurred in the n-bit input stream is counted with respect to all the selected word sizes (w1, w2, . . . ) and occurrence probability is defined. The minimum entropy (Hmin) values (H_{min,w1}^{00 . . .} , H_{min,w1}^{11 . . .} , . . . , H_{min,w2}^{0000 . . .} , H_{min,w2}^{1111 . . .} ) corresponding thereto are calculated.

To calculate a Hmin matrix, effective linear approximate methods may be used to take up less computational resources. Using a mathematical formula 2 below, variation values may be calculated on every selected pair of different word sizes (wᵢ<wⱼ<<n, wᵢ≠wⱼ).

$${V}_{{w}_{j} , {w}_{i}}^{0} = {H}_{min , {w}_{j}}^{0000 …} - \frac{{w}_{j}}{{w}_{i}} {H}_{min , {w}_{i}}^{00 …} ; \\ {V}_{{w}_{j} , {w}_{i}}^{1} = {H}_{min , {w}_{j}}^{1111 …} - \frac{{w}_{j}}{{w}_{i}} {H}_{min , {w}_{i}}^{11 …} . \qquad [ Mathemathical formula 2 ]$$

Finally, health of random numbers being output from the random number generator 120 may be determined based on a mathematical formula 3 below.

V_{wj,wi}⁰<e=f(wᵢ,wⱼ,n);

V_{wj,wi}¹<e=f(wᵢ,wⱼ,n). [Mathematical formula 3]

Herein, wᵢ is a first word size, wⱼ is a second word size, n is an input stream (n) as a true random number (TRN) and e is a reference value.

Accordingly, the random number health test method according to some example embodiments of the inventive concepts can effectively perform an on-line test on random numbers using a statistical property of a random sequence and an algebraic property of the minimum entropy (Hmin) estimation matrix. The random number health test method may be adjusted according to a word size of an input stream (n) and/or the degree of precision of a test, and thus can be flexibly embodied for different security applications.

Other example embodiments testing health of random numbers are described below. For explanation purposes, two words are limited to a first word (‘1 . . . ’) constituted by ‘1’ and a second word (‘0 . . . ’) constituted by ‘0’.

FIG. 4 is a block diagram illustrating an example embodiment realizing a random number health test method in accordance with the inventive concepts. Referring to FIG. 4, four counters for counting the number of occurrences of words of ‘0’, ‘1’, ‘0000’ and ‘1111’ are used. After completing a counting operation, suitable great values are selected in maximum blocks and probability values Pr corresponding to the values are calculated. Then, the minimum entropy (Hmin) values (Hmin, w1, Hmin, w2) are calculated and variation values (V_{w2,w1}) are defined by a mathematical formula 4 below.

$${V}_{{w}_{2} , {w}_{1}} = {H}_{min , {w}_{2}} - \frac{{w}_{2}}{{w}_{1}} {H}_{min , {w}_{1}} \qquad [ Mathematical formula 4 ]$$

In FIG. 4, a first word size (w1) is 1 and a second word size (w2) is 4. Thus, a health determination function value T becomes Hmin_{—}4−4Hmin_{—}1.

The variation value (V_{w2,w1}) (e.g., the health determination function value T) determines whether health of random numbers is smaller than a reference value (e). As a result, health of random numbers is determined. If the calculated health determination function value T is smaller than the reference value (e), the minimum entropy (Hmin) is output as a random number. If not, an error ERR is output.

In FIG. 4, a count operation may be performed on all the words (e.g., ‘1’, ‘0’ when w=1, ‘1111’, ‘0000’ when w=4) of a same word size, a probability value may be calculated on the maximally counted word, and the minimum entropy (Hmin) may be calculated using the calculated probability value. However, the inventive concepts are not limited thereto. It is not necessary for the inventive concepts to perform a counting operation on all the words of a same word size.

FIG. 5 is a block diagram illustrating another example embodiment realizing a random number health test method in accordance with the inventive concepts. Referring to FIG. 5, to reduce computational resources as compared with FIG. 4, three counters are used to count the number of occurrences of words of ‘0’, ‘1’ and ‘11.’

The first minimum entropy (Hmin_{—}1=f(Pr(‘0’))) of ‘0’, the second minimum entropy (Hmin_{—}1=f(Pr(‘1’))) of ‘1’, and the third entropy (Hmin_{—}2=f(Pr(‘11’))) of ‘11’ are calculated and a health estimation function value T is calculated using the second minimum entropy (Hmin_{—}1=f(Pr(‘1’))) and the third entropy (Hmin_=f(Pr(‘11’))). If the health estimation function value T is smaller than the reference value (e), the difference value between the first minimum entropy (Hmin_{—}1=f(Pr(‘0’))) and the second minimum entropy (Hmin_{—}1=f(Pr(‘1’))) is output as a minimum entropy (Hmin).

In FIG. 5, a count operation is performed on all words (e.g., ‘0’, ‘1’) of one word size (e.g., w=1). However, the inventive concepts are not limited thereto. The inventive concepts may be embodied such that the count operation is performed on one word size to take up less computational resources.

FIG. 6 is a block diagram illustrating still another example embodiment realizing a random number health test method in accordance with the inventive concepts. Referring to FIG. 6, to take up less computational resources as compared with FIG. 5, only two counters are used to count the number of occurrences of ‘1’ and ‘1111’ words. The number of occurrences for ‘0’ word can be obtained by simply changing the number of occurrences for ‘1’ word. The random number health test method illustrated in FIG. 6 is the same as or similar to that in FIG. 5 except a process of converting ‘1’ into ‘0’ when performing a count operation on ‘0’.

To implement a random number generator in a limited environment (e.g., embedded devices), efficient calculation of the minimum entropy (Hmin) value is desirable. For example, an approximation method based on the characteristic of the minimum entropy (Hmin) may be suggested as an efficient approximation method for the minimum entropy (Hmin). The characteristic of the minimum entropy (Hmin) may be substantially linear in some specific pieces.

FIG. 7 is a drawing illustrating a 2-piece linear approximation of a minimum entropy (Hmin) function dependent on a value of Pr(1).

FIG. 8 is a drawing illustrating an error rate (%) with respect to the ideally calculated minimum entropy (Hmin) value. In the linear approximation, any number of pieces may be used to reduce computational errors.

The approximation method of the minimum entropy (Hmin) according to some example embodiments of the inventive concepts uses the linear property of the minimum entropy (Hmin) function and uses a piece-linear approximation of log₂ function in some ranges. To effectively calculate the minimum entropy (Hmin), decomposition of the numbers and multiplication may be used. Multiplication may be implemented using low-cost shift operation. The approximation method of the minimum entropy (Hmin) may be adjusted according to a word size of an input stream (n) and/or computation precision.

FIG. 9 is a flow chart illustrating a piece linear approximation method for the minimum entropy (Hmin) function in accordance with an example embodiment of the inventive concepts. Referring to FIG. 9, a range of approximation coefficients corresponding to a probability of any one word is selected (S210). Coefficients of piece linear approximation corresponding to the selected range are applied to the computation block (S220). The coefficients of piece linear approximation are different from one another depending on selected ranges. The computation block calculates the minimum entropy (Hmin) using the applied coefficient of piece linear approximation (S230).

FIG. 10 is a drawing illustrating a piece linear approximation method for the minimum entropy (Hmin) function in accordance with an example embodiment of the inventive concepts. Referring to FIG. 10, the piece linear approximation method satisfies a mathematical formula 5 below.

$$[ Mathematical formula 5 ]$$

$${H}_{min} = \{ \begin{matrix}P \cdot ( - {k}_{11} - {k}_{12} - … - {k}_{1 i} - {k}_{1 i - 1} - … ) + {C}_{1} , & ∀ P ∈ ( {b}_{1} , {b}_{2} ) \\ P \cdot ( - {k}_{21} - {k}_{22} - … - {k}_{2 i} - {k}_{2 i - 1} - … ) + {C}_{2} , & ∀ P ∈ ( {b}_{3} , {b}_{4} ) \\ … & \\ P \cdot ( - {k}_{n 1} - {k}_{n 2} - … - {k}_{ni} - {k}_{ni - 1} - … ) + {C}_{n} , & ∀ P ∈ ( {b}_{2 n - 1} , {b}_{2 n} )\end{matrix} \\ P \cdot {k}_{ij} = \{ \begin{matrix}P >>> {K}_{ij} , & ∀ {k}_{ij} > 1 \\ P >>> {K}_{ij} , & ∀ {k}_{ij} < 1\end{matrix}$$

To implement the equation described above, a memory table may be used. A plurality of decomposed coefficients of the piece linear approximation may be stored in the memory table. Coefficients for appropriate range of Pr(1) may exist in every row in the memory table. For example, a whole range may be defined by some numbers (bx1, bx2) and some coefficients may be 0.

The piece linear approximation method for the minimum entropy (Hmin) function may proceed as follows. First, calculated value of Pr(1) is input and one specific range among a plurality of ranges is activated by an address select block according to the inputted value. The address select block can be implemented either as an embedded block or a reconfigurable block. Then, a computational procedure begins. According to the activated range, appropriate coefficients of piece linear approximation are applied to a computation block. Consecutive temporary coefficients are calculated in parallel (or alternatively in a consecutive routine). To improve performance of computation, a shift operation may be used when calculating coefficients. Real coefficients of the piece linear approximation may be loaded into the memory table in a factorized form. Finally, the minimum entropy (Hmin) value may be calculated as the sum of the computed temporary coefficients. The sum may be expressed by a positive number or a negative number.

The piece linear approximation method of the minimum entropy (Hmin) may be implemented in various ways. For explanation purposes, the piece linear approximation method is limited to the 2-piece linear approximation method.

FIG. 11 is a drawing illustrating a first example embodiment of a 2-piece linear approximation method for the minimum entropy (Hmin) function in accordance with the inventive concepts. Referring to FIG. 11, a first piece coefficient 2.625 is decomposed into 2+0.5+0.125 and a second piece coefficient 2.125 is decomposed into 2+0.125.

As illustrated in FIG. 11, the number (e.g., four) of coefficients in a first piece and the number (e.g., three) of coefficients in a second piece are different from each other. However, the inventive concepts are not limited thereto. The number of coefficients in a first piece may be equal to the number of coefficients in a second piece.

FIG. 12 is a drawing illustrating a second example embodiment of a 2-piece linear approximation method for the minimum entropy (Hmin) function in accordance with the inventive concepts. Referring to FIG. 12, calculation of the minimum entry (Hmin) includes three steps in first and second pieces, respectively.

As illustrated in FIG. 12, coefficients in a first piece may be different from coefficients in a second piece.

The minimum entropy (Hmin) can be calculated while multiplying numbers corresponding to respective coefficients to reduce a word size of memory required for computation.

FIG. 13 is a drawing illustrating a third example embodiment of a 2-piece linear approximation method for the minimum entropy (Hmin) function in accordance with the inventive concepts. Referring to FIG. 13, calculation of the minimum entry (Hmin) is performed within a fixed word size of binary representation.

The random number generator according to example embodiments of the inventive concepts can be applied to various security systems.

FIG. 14 is a block diagram illustrating a security system including a crypto processor having a random number generator in accordance with some example embodiments of the inventive concepts. Referring to FIG. 14, a security system 1000 includes a central processing unit (CPU) 1100, a crypto processor 1200, a ROM 1300, a RAM 1400, and a crypto memory 1500.

The central processing unit 1100 controls an overall operation of the security system 1000. According to a control of the central processing unit 1100, the crypto processor 1200 decodes a command that makes possible crypto, certification, and an electronic signature, and processes data. The crypto processor 1200 includes a random number generator which tests health of random numbers using the minimum entropy (Hmin) described in FIGS. 1 through 13. The ROM 1300 and the RAM 1400 store data needed to drive the security system 1000. The crypto memory 1500 stores data needed to drive the crypto processor 1200.

The random number generator according to some example embodiments of the inventive concepts can be applied to an eMMC (embedded multimedia card).

FIG. 15 is a block diagram illustrating an eMMC (embedded multimedia card) in accordance with some example embodiments of the inventive concepts. Referring to FIG. 15, an eMMC 3000 may include at least one NAND flash memory device 3100 and a controller 3200. The eMMC 3000 can support an eMMC 4.4 regulation.

The NAND flash memory device 3100 may be a single data rate (SDR) NAND, a double data rate (DDR) NAND, or a toggle NAND. In the embodiment, the NAND flash memory device 3100 may include NAND flash memory device units. The NAND flash memory device units can be stacked in one package (e.g., FBGA, Fine-pitch Ball Grid Array). The controller 3200 is connected to the flash memory device 3100 through a plurality of channels. The controller 3200 includes at least one controller core 3210, a host interface 3250 and a NAND interface 3260.

The controller core 3210 controls an overall operation of the eMMC 3000. The controller core 3210 includes a random number generator 3212 generating a random number being used to correct an error. The random number generator 3212 can be embodied by a random number generator which tests health of random numbers using the minimum entropy (Hmin) described in FIGS. 1 through 13. The host interface 3250 performs an interfacing function between the controller 3210 and a host. In the embodiment, the host interface 3250 may be a parallel interface (e.g., a MMC interface). In another embodiment, the host interface 3250 may be a serial interface (e.g., UHS-II, UFS interface).

The eMMC 3000 is provided with supply voltages Vcc and Vccq from the host. A first supply voltage (Vcc: 3.3V) is provided to the NAND flash memory device 3100 and the NAND interface 3230 and a second supply voltage (Vccq: 1.8V/3.3V) is provided to the controller 3200. In the embodiment, the eMMC 3000 can be optionally provided with an external high voltage Vpp.

The eMMC 3000 may store large amounts of data and have an improved write operation characteristic. The eMMC 3000 can be applied to a mobile device (e.g., a cell phone, a tablet, a gaming console, etc.), thereby reducing the size and power consumption of the mobile device.

As described above, in the random number health test method according to the inventive concepts, the minimum entropies (Hmin) may be calculated on at least two words and health of random numbers may be simply tested using the calculated minimum entropies (Hmin).

Having described some example embodiments of the inventive concepts, it is further noted that it is readily apparent to those of reasonable skill in the art that various modifications may be made without departing from the spirit and scope of the inventive concepts which is defined by the metes and bounds of the appended claims.

What is claimed is:

1. A random number health test method comprising:
generating a random number;
counting occurrences of at least two words in the generated random number, respectively;
calculating probability values corresponding to occurrences of the two counted words;
calculating minimum entropies (Hmin) of the respective probability values; and
determining health of the generated random number using the calculated minimum entropies (Hmin).

2. The method of claim 1, wherein sizes of the two words are different from each other.

3. The method of claim 1, wherein the two words comprise a first word and a second word, the first word consisting of one or more ‘1’ words, the second word consisting of one or more ‘0’ words, and the first and second words being a same size.

4. The method of claim 3, wherein the calculating probability values calculates a first probability value of the first word and a second probability value of the second word.

5. The method of claim 3, wherein the calculating probability values calculates a probability value of a greater count value between a count value of the first word and a count value of the second word.

6. The method of claim 5, wherein the calculating minimum entropies (Hmin) further comprises:
calculating a minimum entropy (Hmin) on the probability value of the greater count value.

7. The method of claim 1, wherein the calculating minimum entropies (Hmin) calculates each of the minimum entropies (Hmin) based on Hₘᵢₙ=−log₂(Pₘₐₓ), wherein Pmax is a probability value of each of the two words.

8. The method of claim 1, wherein the calculating minimum entropies (Hmin) calculates the minimum entropies (Hmin) using a piece linear approximation method, and
wherein the piece linear approximation method uses a table storing a plurality of approximation coefficients corresponding to respective probabilities of a plurality of ranges of the respective counted words.

9. The method of claim 1, wherein the determining health of the generated random number determines the health of the random number using a health determination function value, the health determination function value being a difference between the calculated minimum entropies.

10. The method of claim 1, further comprising:
outputting a smallest minimum entropy (Hmin) among the calculated minimum entropies (Hmin), after determining the health of the random number, as a health result value of the random number.

11. A random number health test method comprising:
generating a random number;
calculating a first minimum entropy (Hmin) of a first word, the first word consisting of one or more ‘1’ words in the generated random number;
calculating a second minimum entropy (Hmin) of a second word, the second word consisting of one or more ‘0’ words in the generated random number;
calculating a health determination function value based on the first and second minimum entropies (Hmin); and
determining whether to output one of the first and second minimum entropies based on a health determination function value and a reference value.

12. The method of claim 11, further comprising:
calculating a third minimum entropy (Hmin) of third word, the third word consisting of one or more ‘0’ words and having a same size as the first word; and
wherein the determining determines to output a smaller one between the first and third minimum entropies (Hmin) as an updated random number if the health determination function value is smaller than the reference value.

13. The random number health test method of claim 11, further comprising:
counting the first word to calculate a probability value of the counted first word;
counting the second word to calculate a probability value of the counted second word; and
counting a third word to calculate a probability value of a third word, the third word consisting of one or more ‘0’ words and having a same size as the first word.

14. The method of claim 11, further comprising:
counting the first word to calculate a probability value of the counted first word;
counting the second word to calculate a probability value of the counted second word; and
changing ‘1’ into ‘0’ in the random number to calculate a probability value of a third word, the third word consisting of one or more ‘0’ words and having a same size as the first word.

15. The method of claim 11, wherein the first word is ‘1’ and the second word is ‘11’.

16. A piece linear approximation method for calculating a minimum entropy (Hmin), the method comprising:
selecting a range of approximation coefficients corresponding to a probability of a word;
applying piece linear approximation coefficients corresponding to the selected range to a computation block; and
computing the minimum entropy (Hmin) using the applied piece linear approximation coefficients.

17. The method of claim 16 further comprising:
decomposing and storing the piece linear approximation coefficients in a memory table.

18. The method of claim 17 further comprising:
loading piece linear approximation coefficients into the memory table in a factorized form.

19. The method of claim 16, further comprising:
calculating temporary coefficients in parallel with the applying or between the applying and the computing.

20. The method of claim 19, wherein the computing includes summing the calculated temporary coefficients to calculate the minimum entropy (Hmin) value.
